(19) United States
(12) Patent Application Publication
(10) Pub. No.: US 2011/0193746 A1
(43) Pub. Date: Aug. 11, 2011

(54) Method of Positioning RFID Tags

(75) Inventor: Chien-Ho Ko, Pingtung (TW)

(73) Assignee: National Pingtung University of Science and Technology, Pingtung (TW)

(21) Appl. No.: 12/881,310

(22) Filed: Sep. 14, 2010

(30) Foreign Application Priority Data
Feb. 9, 2010 (TW) 99104047

(51) Int. Cl. G01S 3/02; G06K 7/01

(52) U.S. Cl. 342/450; 340/10.4

(57) ABSTRACT

A method of positioning a RFID tag by using four antennas associated with an algorithm is disclosed. A positioning space is sliced into several spatial boxes with an equal size. The center of each spatial box is assumed roughly as the target position and thus the positions are used to calculate the average errors and root mean square errors. Thereafter, the errors of all spatial boxes are compared and chosen the smallest error one from them as a new positioning space. The RMSE of the selected spatial box is then compared to a predetermined value. A correcting quantity in three axial directions is then added on the coordinate of the initial position and served as a new initial position. The processes repeated till the RMSE meets the termination condition.

### FIELD OF THE INVENTION

The present invention is related to a RFID tag, particularly, to a positioning method using an algorithm.

### BACKGROUND OF THE INVENTION

Nowadays, communication over wireless technique is widely applied on our daily lives. It brings us extreme convenience and usefulness on many aspects. Positioning is an example of applying the wireless technique. The known techniques about positioning include global positioning system (GPS), Cell identification, infrared, IEEE 802.11, supersonic, Ultra-wideband, Zig-bee, radio frequency identification (RFID), etc. GPS provides precisely positioning with low cost; however, it is appropriate for outdoor use only. Cell ID and super-wide band are apt in large district positioning. Infrared position is known for environmental interference-prone and high cost for apparatus installation. The performances of IEEE 802.11 and Zig-Bee techniques in positioning have been found not as good as expectation. Cost for constructing a supersonic positioning system is usually expensive.

RFID positioning system is an automatic identification system without direct contact. The RFID tag broadcasts radio frequency out so as to transmit identification message. An identification system is composed of RFID tags and readers. Each RFID tag contains a circuit thereon, intermittently emitting signals when a reader attempts to access the information written on the RFID tags in distance. RFID tag essentially is a silicon chip with a simple antenna formed thereon and then capsulated by glass or plastic film.

A RFID system for indoor positioning was first proposed by HighTower and Borriello in 2001. The research developed a SpotON positioning system to verify the feasibility of using RFID in indoor positioning. In the method of SpotON, unknown positions are not processed by the central control console but are approached by many local detectors. The respond signals, i.e. RSSI (radio signal strength indicator), transmitted from many local detectors distributed in the environment are collected. The RSSI is then analyzed by a positioning algorithm to determine the positions of the article.

RFID positioning is especially apt to indoor use by taking advantage of low cost for system setup. In 3-D (three dimensional) space, for positioning a target RFID tag, one RFID antenna can constitute a sphere surface only and two RFID antennas can constitute a joint area of two spheres. The third additional antenna can further position the target to two possible answers. To obtain a merely reasonable solution, four antennas are generally demanded.

Referring to FIG. 1, it shows three signal transmitter (or stations) with known positions provided to locate a target tag. Each transmitter transmitting a radio signal outward constitutes a sphere as shown in figure. The coordinate of the transmitters are respectively, located at (X=0,Y=0), (X=1,Y=0), and (X=3,Y=0). The coverage radiuses of them are r1, r2, and r3, respectively. The unknown position can be determined by the intersection of them. With the same concept, utilizing four transmitters to transmit signals are generally called Multilateration.

A prior art about the positioning space algorithm called SPA 1.0, using gradient descent method with an application Ser. No. 12/955,921 cooperated hereby for reference. In the SPA 1.0, a position at the center of position space is guessed initially then a root mean square error (RMSE) is calculated. If the RMSE is larger than a predetermined criterion then three correcting quantities are, respectively, added to the three axial initial coordinates so as to gradually approaching the target position.

Another prior art embodiment for positioning named SPA 2.0, whose procedures include slicing a positioning space into N-equal size spatial boxes or N-equal size plus one unequal spatial box if it has remnant. The center of the every spatial box is assumed to be a possible position of the target RFID tag. The root mean square errors of the all spatial boxes based on the centers are then calculated and compared to choose one spatial box having a minimum RMSE among them. The method requires the spatial box small enough since the error relays on the size of the spatial box.

### SUMMARY OF THE INVENTION

The present invention discloses a method of positioning a RFID tag called SPA3.0, which combines SPA 1.0—a local gradient correction and SPA 2.0—sliced a positioning space into several spatial boxes.

The method of positioning a RFID tag comprises the steps of: (a) arranging four antennas in a position space having a RFID tag to be positioned therein and measuring distances sₖ, a distance between the antenna k and the target RFID tag according to a diagram of RSSI-distance; (b) slicing the position space into N spatial boxes such as 8; (c) calculating distances Sᵢₖ (i=1 to N, k=1 to 3), each being a distance between a center of a spatial box i and the antenna k; (d) calculating root mean square errors(RMSEs) εᵢ, each being a root mean square error of a spatial box i and comparing the RMSEs εᵢ, and choosing a spatial box m which has a minimum εₘ among the RMSEs εᵢ; (e) using a coordinate (xᵢ,yᵢ,zᵢ), the center of the m^{th} spatial box as an initial position for performing gradient descent procedures, which is operated including a adjusting quantity for each iteration j and provides a predetermined criterion η as an END condition of the gradient descent procedures; (f) using (xᵢ,yᵢ,zᵢ) as a final position of the target RFID tag if εₘ(j)<η and ends the gradient descent procedures; (g) adding correcting quantity (Δxᵢ(j),Δyᵢ(j),Δzᵢ(j)) on initial position as a new initial position and repeating the steps (f) to (g).

In a second preferred embodiment, at least four spatial boxes with the minimum average error for four antennas are calculated and selected, respectively. After that a spatial box among at least four spatial boxes is further chosen, which is the one in common indicated by different antennas and is selected as a new position space for performing the SPA 1.0 method.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a schematically diagram for 3-D RFID spatial positioning according to prior art.

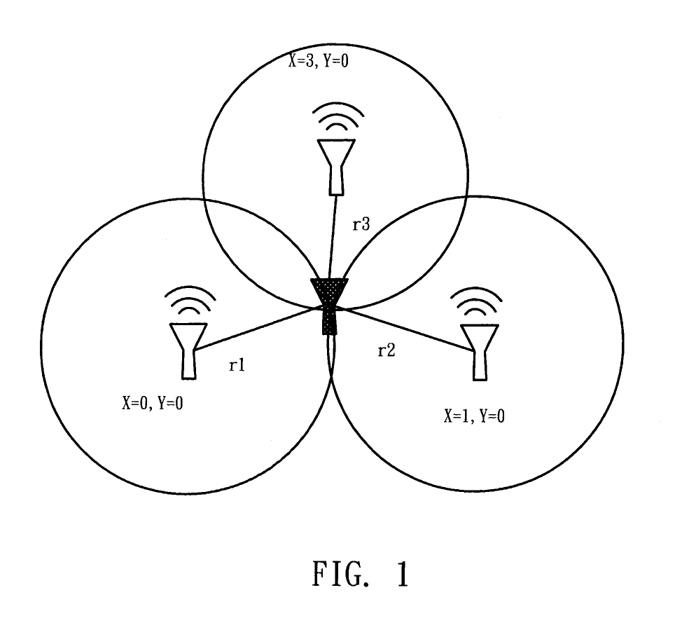

FIG. 2 shows a flowchart in accordance with the algorithm (SPA 3.0) of the present invention.

FIG. 3 shows RSSI-distance curves in accordance with the present invention.

FIG. 4 shows a flowchart in accordance with another preferred embodiment of the algorithm (SPA 3.0) of the present invention.

### DETAILED DESCRIPTION OF THE PREFERRED EMBODIMENT

A RFID reader including an antenna can be used to read radio frequency strength indicators (RSSI) emitted from the RFID tags. By means of RSSI, the distance between the target RFID tag and the readers can be determined but the precise position of the target RFID tag is still unknown. Thus as forgoing description in the background of the invention, at least three antennas are demanded (but four are preferred since it may have two possible positions). In the present invention, the fourth antenna is used to obtain an unique solution.

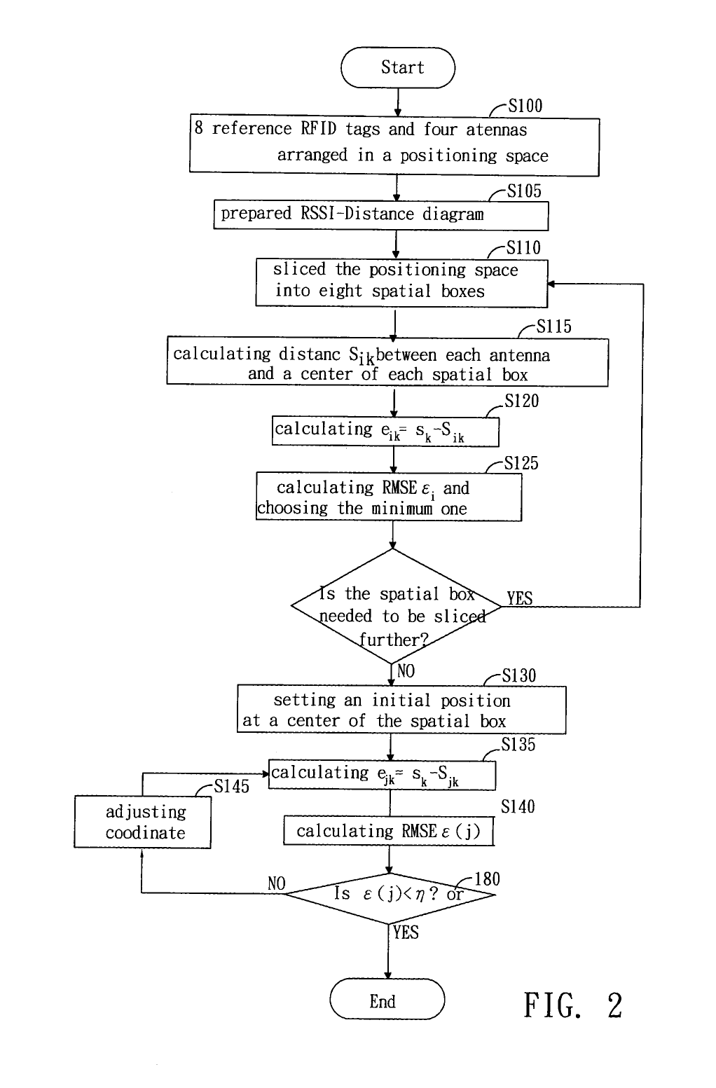

The present invention discloses a positioning method named space algorithm 3.0, abbreviated as SPA 3.0, which combines advantages of both of SPA 1.0 and SPA 2.0. In method SPA 3.0, the positioning space is sliced into several such as eight spatial boxes at first. The errors for all spatial boxes are calculated and then compared each other. The error may be a root mean square error or just an average error. The spatial box having a minimum error is then selected as an updated positioning space to carrier out the method of SPA 1.0, a gradient descent procedure, to approach the position of target RFID tag. The steps are shown in FIG. 2 using a flowchart.

Referring to step 100, a plurality of reference RFID tags, such as eight, uniformly installed in the position space are conducted to provide RSSI reference values. The reference RFID tags distributed uniformly are to make the signals coming from different directions so as to reduce the measured errors while reading by four antenna readers. On the other hand, it can also reduce the required number of the reference RFID tags.

Referring to step 105, RSSI value-distance diagram are established according to the data of RSSI values read from the reference RFID tags one after one by each RFID reader.

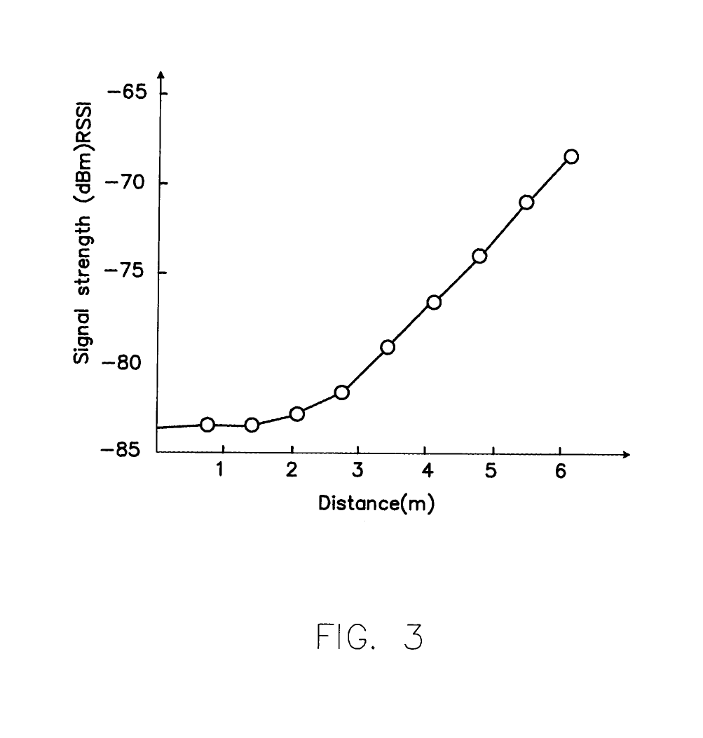

Owing to the RSSI values vulnerable to the various environmental factors, each RFID reader vs the reference RFID tags to build one RSSI value-distance is preferred. An example of which is shown in FIG. 3.

Referring to the step 110, the position space is sliced into N number such as eight of cubic spatial boxes with an equal size in a preferred embodiment. The remnant if it exists is seen as one additional spatial box. The number or the size of each spatial box depends on a predetermined average error that can be tolerant.

In step 115, the distances Sᵢₖ are calculated. Where i=1 to N and k=1 to 4. The Sᵢₖ is a straight distance between a center of the i^{th} spatial box and the k^{th} antenna. Therefore, in this step 4N of distances are calculated.

In step 120, each error eᵢₖ is then calculated. The error eᵢₖ is the difference between the measured sₖ and the calculated Sᵢₖ i.e. eᵢₖ=sₖ−Sᵢₖ where the sₖ is a measured distance between the k^{th} antenna and the target RFID, k=1, 2, 3, 4.

In step 125, RMSE εᵢ for the i^{th} spatial box is expressed as

$${ɛ}_{i} = \sqrt{\frac{{\sum }_{k = 1}^{m} {( \frac{{s}_{k} - {S}_{ik}}{{s}_{k}} )}^{2}}{m}} .$$

In the embodiment, εᵢ, where i=1, . . . , 8 are calculated, m is of 4, the total numbers of the antenna.

All of the errors of mean square root εᵢ are compared to choose the minimum ε_{i,min} among them. The ε_{i,min} is then compared with the conditions, e.g. a first predetermined value η₁ and the second predetermined value η₂. In a first preferred embodiment, has a size 10³ cm³ to 1.25×10⁵ cm³. If the ε_{i,min} is larger than the first predetermined value η₁, the spatial box is sliced again so that the steps 110 to 125 are repeatedly. Otherwise, the step 130 is followed.

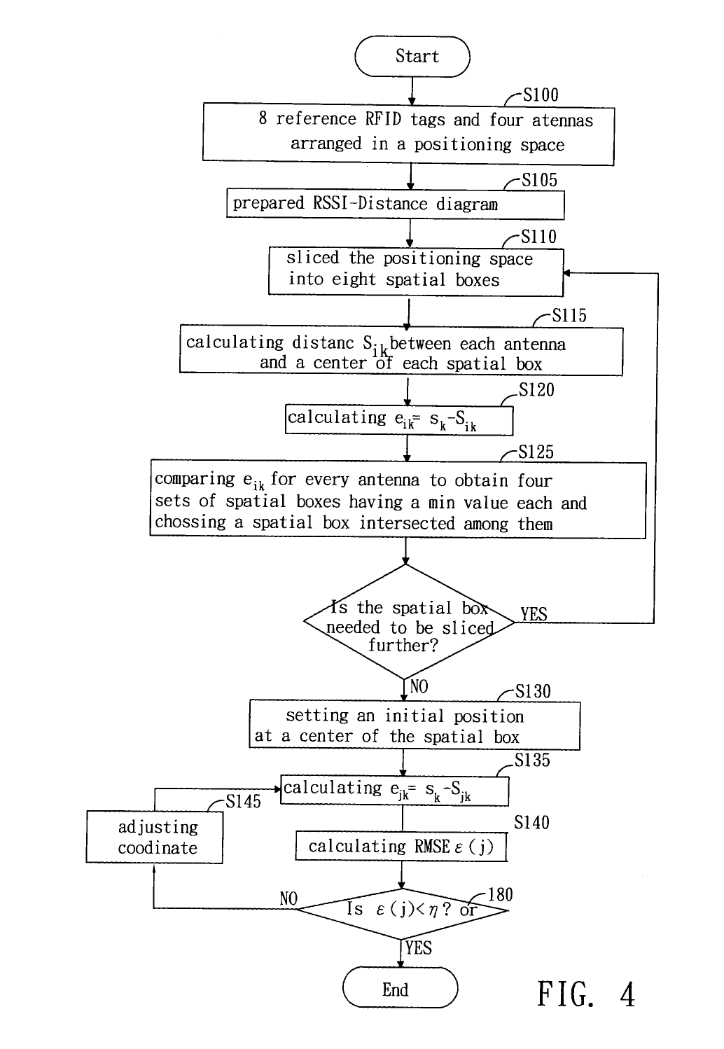

In a second preferred embodiment the eᵢₖ is compared rather than the RMSE εᵢ, as seen in the flowchart in FIG. 4. As a result, four sets of eᵢₖ are obtained for four antennas. In each set of eᵢₖ, a minimum e_{ik,min} is chosen among eᵢₖ. Therefore, there are at least four spatial boxes indicated, respectively, by four antennas 1, 2, 3, and 4. In an ideal case, only one spatial box is pointed out by different antennas but in non-ideal case, it may more than one. For instance, assumed antennas 1, 2, 3 simultaneously pointed out the fifth spatial box having the minimum error i.e. e_{i1,min}, e_{i2,min}, e_{i3,min}; where i=5 then the fifth spatial box is selected preferably as a new position space to proceed the SPA 1.0 method since it has the most intersections. After that the RMSE for the fifth spatial box is calculated. If the ε_{5,min} is larger than the first predetermined value η₁, the spatial box is sliced again so that the steps 110 to 125 can be repeatedly. Otherwise, the step 130 is followed.

In step 130, the center of the selected spatial box having a coordinate (xᵢ,yᵢ,zᵢ) is served as the initial guessed position. The ending conditions, an iteration number η₃ or a RMSE criterion η₄, are predetermined for iterations. The η₃ may be between about 5-15 and the η₄ may be between about 0.05-0.1.

In step 135, the RMSE εᵢ=ε(0)=ε(j)=ε_{i,min} of the selected spatial box is compared with the η₄. If ε(j)≦η₄ then the coordinate (xᵢ,yᵢ,zᵢ) is the estimated target position, and ends the procedures further, where j represents the j^{th} iteration. Otherwise, a correcting quantity (Δxᵢ(j),Δyᵢ(j),Δzᵢ(j)) is added on (xᵢ,yᵢ,zᵢ). The generic equations are represented as follows:

$$( {x}_{i} ( j + 1 ) , {y}_{i} ( j + 1 ) , {z}_{i} ( j + 1 ) ) = \{ \begin{matrix}{x}_{i} ( j + 1 ) = {x}_{i} ( j ) + Δ {x}_{i} ( j ) \\ {y}_{i} ( j + 1 ) = {y}_{i} ( j ) + Δ {y}_{i} ( j ) \\ {z}_{i} ( j + 1 ) = {z}_{i} ( j ) + Δ {z}_{i} ( j )\end{matrix}$$

Wherein the correcting quantity (Δxᵢ(j),Δyᵢ(j),Δzᵢ(j)) is assumed to be a product of adjustability (αₓ,α_{y}, α_{z}), current coordinate (xᵢ(j),yᵢ(j),zᵢ(j)), and local gradient (δₖ). It is thus expressed as:

$$( Δ {x}_{i} ( j ) , Δ {y}_{i} ( j ) , Δ {z}_{i} ( j ) ) = \{ \begin{matrix}Δ {x}_{i} ( j ) = {α}_{x} {x}_{i} {δ}_{k} \\ Δ {y}_{i} ( j ) = {α}_{y} {y}_{i} {δ}_{k} \\ Δ {z}_{i} ( j ) = {α}_{z} {z}_{i} {δ}_{k}\end{matrix}$$

Where αₓ, α_{y}, α_{z} are the adjustabilities along the X-axis, Y-axis, and Z-axis, respectively. Each value is ranging from 0.00000005 to 0.0000001 depending on the size of the selected spatial box. If a result estimated target position is out of spatial box while proceeding the iteration processes, less adjustability values by one or two order(s) of magnitude would be preferred. The local gradient δₖ for the antenna can be determined by the product of Sⱼₖ and eⱼₖ where Sⱼₖ is the estimated distance between the antenna k and the estimated target RFID tag that is the initial coordination after the j^{th} iteration and the eⱼₖ is the difference between the measured distance and the estimated distance for the k^{th} antenna at the j^{th} iteration. The equation is thus formulated as follows:

δₖ=Sⱼₖ×eⱼₖ.

The coordinate (xᵢ(j+1),yᵢ(j+1),zᵢ(j+1)) of the (j+1)^{th} iteration is set as a new initial coordinate. That is:

(Xᵢ(j),Yᵢ(j),Zᵢ(j))=(xᵢ(j+1),yᵢ(j+1),zᵢ(j+1)).

The benefits of the preferred invention are:
(1) Instead of using an entire positioning space, a small spatial box is selected for positioning only so that the computational time for SPA1.0 can be significantly reduced; and
(2) The derived target position can be more precise with less time and iterations. In the method SPA 1.0, the positioning could be more precise but it takes longer to approach. The method SPA 2.0, however, is the opposite, shorter searching time but the position found is usually not precise.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

What is claimed is:

1. A method of positioning a target RFID tag, said method comprising the steps of:
(a) arranging three antennas in a position space having a target RFID tag to be positioned therein and measuring distances sₖ, a distance between said antenna k and the target RFID tag according to a diagram of RSSI-distance;
(b) slicing the position space into N spatial boxes;
(c) calculating distances Sᵢₖ (i=1 to N, k=1 to 3), each being a distance between a center of a spatial box i and the antenna k;
(d) calculating root mean square errors (RMSEs) εᵢ, each being a root mean square error of a spatial box i and comparing said RMSEs εᵢ and choosing a spatial box m which has a minimum εₘ among said RMSEs εᵢ;
(e) using a coordinate (xᵢ,yᵢ,zᵢ), the center of spatial box m, as an initial position for performing gradient descent procedures, which is operated including a adjusting quantity for each iteration j and provides a predetermined criterion η as an END condition of said gradient descent procedures;
(f) using (xᵢ,yᵢ,zᵢ) as a final position of the target RFID tag if εₘ(j)<η and ending said gradient descent procedures;
(g) adding a correcting quantity (Δxᵢ(j),Δyᵢ(j),Δzᵢ(j)) on initial position as a new initial position and repeating the steps (f) to (g).

2. The method according to claim 1 wherein the diagram of RSSI-distance is built by the steps of:
distributing a plurality of reference RFID tags with predetermined positions in said position space;
measuring RSSI values of said reference RFID tags by said antennas;
plotting RSSI-distances for each of said antennas in accordance with said predetermined positions and measured RSSI values.

3. The method according to claim 1 wherein the spatial boxes are either cubic or cuboids and with a size depends on a predetermined average error to be tolerant.

4. The method according to claim 1 further comprising a fourth antenna at the step (a) and following the step (b) to the step (g).

5. The method according to claim 1 further comprising slicing the spatial box m if said minimum εₘ is larger than a predetermined second criterion value.

6. The method according to claim 1 wherein said step (e) further comprises using a predetermine iteration number as an ending condition of said gradient descent procedures.

7. The method according to claim 1 wherein said correcting quantity
$$( Δ {x}_{i} ( j ) , Δ {y}_{i} ( j ) , Δ {z}_{i} ( j ) ) = \{ \begin{matrix}Δ {x}_{i} ( j ) = {α}_{x} {x}_{i} {δ}_{k} \\ Δ {y}_{i} ( j ) = {α}_{y} {y}_{i} {δ}_{k} \\ Δ {z}_{i} ( j ) = {α}_{z} {z}_{i} {δ}_{k}\end{matrix}$$

8. A method of positioning a RFID tag, said method comprising the steps of:
(a) arranging four antennas in a position space having a RFID tag to be positioned therein and measuring distances sₖ, a distance between said antenna k and the target RFID according to a diagram of RSSI-distance;
(b) slicing the position space into N spatial boxes;
(c) calculating distances Sᵢₖ (i=1 to N, k=1 to 4), each being a distance between a center of a spatial box i and the antenna k;
(d) calculating errors eᵢₖ, and eᵢₖ=sₖ−Sᵢₖ where sₖ is a measuring distances, a distance between said antenna k and the target RFID according to a diagram of RSSI-distance;
(e) comparing eᵢₖ for each antenna k so that each has one or more spatial boxes with a minimum error eₘ₁ for antenna 1, eₙ₂ for antenna 2, eₒ₃ for antenna 3; e_{q4} for antenna 4;
(f) choosing a spatial box which is a intersection spatial box in between said spatial boxes m, n, p, q;
(g) using a coordinate (xᵢ,yᵢ,zᵢ) the center of spatial box m, as an initial position for performing gradient descent procedures, which is operated including a adjusting quantity for each iteration j and provides a predetermined criterion η as an END condition of said gradient descent procedures;
(h) calculating root mean square errors(RMSEs) εᵢ, each being a root mean square error of a spatial box i and comparing said RMSEs εᵢ and choosing a spatial box m which has a minimum εₘ among said RMSEs εᵢ;
(i) using (xᵢ,yᵢ,zᵢ) as a final position of the target RFID if εₘ(j)<η and ending said gradient descent procedures;
(j) adding correcting quantity (Δxᵢ(j),Δyᵢ(j),Δzᵢ(j)) on initial position as a new initial position and repeating the steps (g) to (j)

9. The method according to claim 8 wherein the diagram of RSSI-distance is built by the steps of:
distributing a plurality of reference RFIDs with predetermined positions in said position space;
measuring RSSI values of said reference RFIDs by said antennas;
plot RSSI-distances for each of said antennas in accordance with said predetermined positions and measured RSSIs values.

10. The method according to claim 8 wherein the spatial boxes are either cubic or cuboids and with a size depends on a predetermined average error to be tolerant.

11. The method according to claim 8 further comprising slicing the spatial box m if said minimum εₘ is larger than a predetermined second criterion value.

12. The method according to claim 8 wherein said step (e) further comprises using a predetermine iteration number as an ending condition of said gradient descent procedures.

13. The method according to claim 8 wherein said correcting quantity is
$$of ( Δ {x}_{i} ( j ) , Δ {y}_{i} ( j ) , Δ {z}_{i} ( j ) ) = \{ \begin{matrix}Δ {x}_{i} ( j ) = {α}_{x} {x}_{i} {δ}_{k} \\ Δ {y}_{i} ( j ) = {α}_{y} {y}_{i} {δ}_{k} \\ Δ {z}_{i} ( j ) = {α}_{z} {z}_{i} {δ}_{k} .\end{matrix}$$
